(19) United States
(12) Patent Application Publication
(10) Pub. No.: US 2016/0041815 A1
(43) Pub. Date: Feb. 11, 2016

(54) Computer Source Code Generator for Building Software Applications

(71) Applicant: Chirag P. Bhagat, Kendall Park, NJ (US)

(72) Inventor: Chirag P. Bhagat, Kendall Park, NJ (US)

(21) Appl. No.: 14/457,028

(22) Filed: Aug. 11, 2014

(51) Int. Cl. G06F 9/44; G06F 17/30

(52) U.S. Cl. CPC G06F 8/36; G06F 17/30424

(57) ABSTRACT

A computer program/software/tool that uses a method/technique/process and set of parameters for generating source code for a programming/database/scripting languages straight from a database model or database objects such as Tables, Views, Stored Procedures, User Defined Functions, Types, Sequences, Packages, Indexes and Constraints etc. The method includes steps of creating/generating re-usable program/components/source code for an application, where the developer selects the database object and the type of code they want to generate as an input to the code generator. The code generation method/technique/process utilizes information contained in the database system for the selected database object; uses specific code template; and uses set of parameters provided by the developer and generates source code as an output. A simple two-step process greatly reduces developer effort in going through many code generation options every time they want to generate the code either for an application or an individual component/program.

### BACKGROUND OF THE INVENTION

This invention relates to computer source code generation.

Due to continuous changes and complex business requirements for building software applications, it is becoming very difficult for a software programmer to keep up with the changes, build new software or change existing software in a fast paced environment. The code generation is a great way to increase programmer productivity and build bug free software easily and efficiently. The use of automatically generated code may reduce development time, effort and increase stability of code and ultimately the stability of a software application/tool.

Application developers use different design approach/framework that they like based on their specific requirement; size or type of a software application. The same developers may use different design approach for another software application. However, the code generation tools in today's market target generating application with only specific design/framework or type of applications, which limits the developers use different framework to build their software application. This defeats the purpose of the code generation and does not help application developers in their day to day requirements/changes.

Application developers may already be working on an existing application where they just need to enhance an existing application by adding new set of components/program code to meet the new business requirements/changes and may not need to generate an entire application/framework from scratch.

The main objective of the present invention is to enable generate the true source/program code for an entire software application/tool or an individual, smaller and re-usable components/program using various different types of design in consideration which can be easily used/integrated in any size or type of software applications (console based, windows based, web based, mobile apps etc.) and can be used either to build a new software or enhance an existing software application.

This invention provides a simple, unique and intelligent way of generating the real source code for either an entire application or an individual re-usable component of software so that many benefits can be achieved. It allows the developers to generate the code that adheres to their standard, reduces repetitive coding and provides bug free code. The programmers or developers can easily pick the generated code or script that they really need and can easily add/integrate the same into their new/existing software application or framework. This tool provides verity of code generation templates and parameter settings which makes it very easy to generate the required source code using a simple one-step or two-step process also called “Quick Generation”. No questions are asked to the developer while utilizing Quick Generation method. The developer does not need to go through various step wizard/settings to generate the code and intelligent techniques/settings/naming standards are applied during code generation process. The code templates will be provided by the invention in subject and are easily customizable based on developer's needs for their specific project(s). The developers does not need to write a program or build code templates to generate source code for a component/program, while still providing ability to modify the code templates.

### FIELD OF THE INVENTION

This invention relates to computer source code generation, more specifically to source code generated in the context of component-based programming. in particular, using a set of generation instructions, methods and parameters, the code generator produces nearly-repetitive and repetitive source code, ready for use by the developer in building any size or type of software applications.

### SUMMARY OF THE INVENTION

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

The present invention is a productivity application designed to help application developers generate the real source/program code for an entire software application/tool or an individual, smaller and re-usable components/program using various different types of design in consideration which can be easily integrated in any size or types of software applications ;console based, windows based, web based, mobile, apps etc.) and can be used either to build a new or enhance an existing software application.

### BRIEF DESCRIPTION OF THE DRAWINGS

The following is the brief description of the invention with reference to the figures, in which

FIG. 1 is a General diagram of a code Generation process showing input, process and output.

FIG. 2 is an elaborated flowchart diagram of a source code generation process from a database object as shown schematically in FIG. 1.

FIG. 3 is the exemplary depiction of a display that may be displayed by a graphical user interface that shows various parts of the screen used to generate the source/program code based on selected object, code template and set of rules/settings applied to capture dynamic knowledge;

FIG. 4 is a flowchart diagram of the source code generation process from a database stored procedure/function/UDF.

FIG. 5 is an exemplary depiction of a display that may be displayed by a graphical user interface to facilitate code generation process shown in FIG. 4.

FIG. 6 is a diagram that illustrates an N-tier software architecture.

FIG. 7 is a flowchart diagram of a method/process to define lookup table for a database table/view object that will be used when generating source code.

FIG. 8 is an exemplary depiction of a display that may be displayed by a graphical user interface to facilitate defining lookup table for a database table/view object shown in FIG. 7.

FIG. 9 is a flow diagram to define virtual/lookup key for a database table/view column/attribute that will be used when generating source code.

FIG. 10 is an exemplary depiction of a display that may be displayed by a graphical user interface to facilitate defining lookup/virtual key for a database table/view column/attribute shown in FIG. 9.

FIG. 11 is a flow diagram of the source code generation process that can generate hierarchical user interface/components from a database table/view by defining relationship between columns.

FIG. 12 is an exemplary depiction of a display that may be displayed by a graphical user interface to facilitate code generation process shown in FIG. 11.

FIG. 13 is an exemplary depiction of a display that may be displayed by a graphical user interface to define the relationship between columns in order to facilitate code generation process shown in FIG. 11.

FIG. 14 is an exemplary depiction of user interface components 1400 generated by the tool based on the code generation process shown in FIG. 11 showing Tree view and windows explorer like UI components were generated.

FIG. 15 is an exemplary depiction of user interface components generated by the tool showing Search and List components with features such as Paging, Sorting, and Exporting etc.

FIG. 16 is an exemplary depiction of user interface components generated by the tool based on the code generation process shown in FIG. 4 showing Search (Execution) and List components with single/multiple outputs and features such as Paging, Sorting, and Exporting etc.

### DETAILED DESCRIPTION OF THE INVENTION

The invention is better understood by reading the following detailed description of the invention in conjunction with the accompanying drawings shown in the previous section.

The following description of the invention is provided for better understandability of the invention in its best, currently known embodiment. Those skilled in the relevant field will recognize that many changes may be made to the embodiments described here, while still obtaining the beneficial results of the present invention. It will also be apparent that some of the desired benefits of the present invention can be obtained by selecting some of the features of the present invention without utilizing other features. Accordingly, those who work in the field will recognize that many modifications and adaptations to the present invention are possible and may even be desirable in certain circumstances and are a part of the present invention. Thus, the following description is provided as illustrative of the principles of the present invention and not in limitation thereof, since the scope of the present invention is defined by the claims.

The various aspects of the subject invention are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the invention is to cover all modifications, equivalents, and alternatives falling within the spirit and scope of the claimed subject matter.

The word “exemplary” is used herein to mean serving as an example, instance, or illustration. Any aspect or designed described herein as “exemplary” is not necessarily to be construed as preferred or advantageous over other aspects or designs. In addition, while the examples provided utilize the specific programming languages, databases, scripting languages or user interface; numerous alternative programming languages, databases, scripting languages or user interface methods may be used. The terms “developers”, “programmers”, “application developers” and “software developers” are also used synonymously in various part of the document.

Furthermore, the disclosed subject matter may be implemented as a system, method, apparatus, or computer program product using standard programming and/or engineering techniques to produce/generate software source code thereof to control a computer or processor based device to implement aspect detailed herein.

Following is the detailed description of each figure.

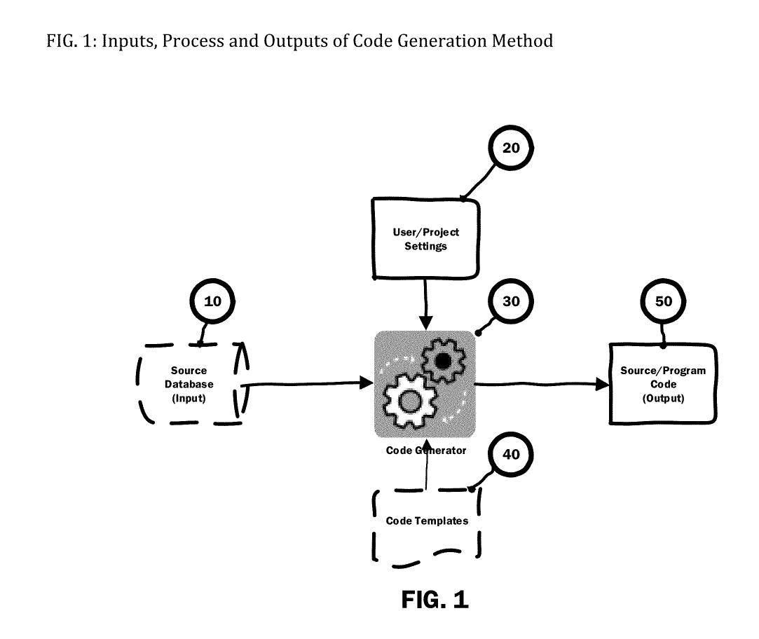

FIG. 1 illustrates the code generator process flow showing Input 10, Process 30 and Output 50 in an exemplary embodiment. The code generator process tool 30 is the main aspect of the invention shown in this figure. The application developer selects the source/database object 10, if not already selected, and/or the type of code template 40 they want to generate the code for as an input 10. The code generation process 30 uses information contained in the database for the selected source/database object, reads specific code template, applies user/project specific settings 20 defined by the user and generates source code as an Output 50.

A simple one-step or two-step process greatly reduces developer effort in going through many code generation options every time they want to generate the code for an application or an individual component/program.

The technique uses pure XML based templates that can be easily modified by a developer so that the developers can customize their code within the templates based on specific method/framework that they use. Additional templates may be created and can be added to the generator tool to provide additional facility to developers to generate code using new patterns/methods/styles.

The technique can be used to generate code for any programming languages/patterns/frameworks including but not limited to C#.NET, VB.NET, ASP.NET, WPF, MVC, MVVM, Java, PHP, Python etc.

The technique can be used to generate code for and using any types of database systems including but not limited to SQL Server, Oracle, MS Access, MS Excel, Sybase, SQL Azure, MySQL etc.

The technique can be used to generate code for entire application or an individual component/program based on the input selection (input selection including but not limited to Tables, Views, Stored Procedures, User Defined Functions, Types, Sequences, Packages, Indexes and Constraints etc.).

This code generator user interface enables a developer to provide various configuration options such as Output directory and Namespaces for different types of code, a database type, provider type etc.

The code template files contains various code blocks along with various variables for string replacement as per the developer's needs for code generation. The code generator supports multiple code templates which can easily be modified to customize the code. The templates can be created for any layer of the application. Different user interface layer templates can be created including but not limited to, Web, Windows and mobile. The code generator tool reads the code template files, makes intelligent string replacements and then generates the source code for the selected template.

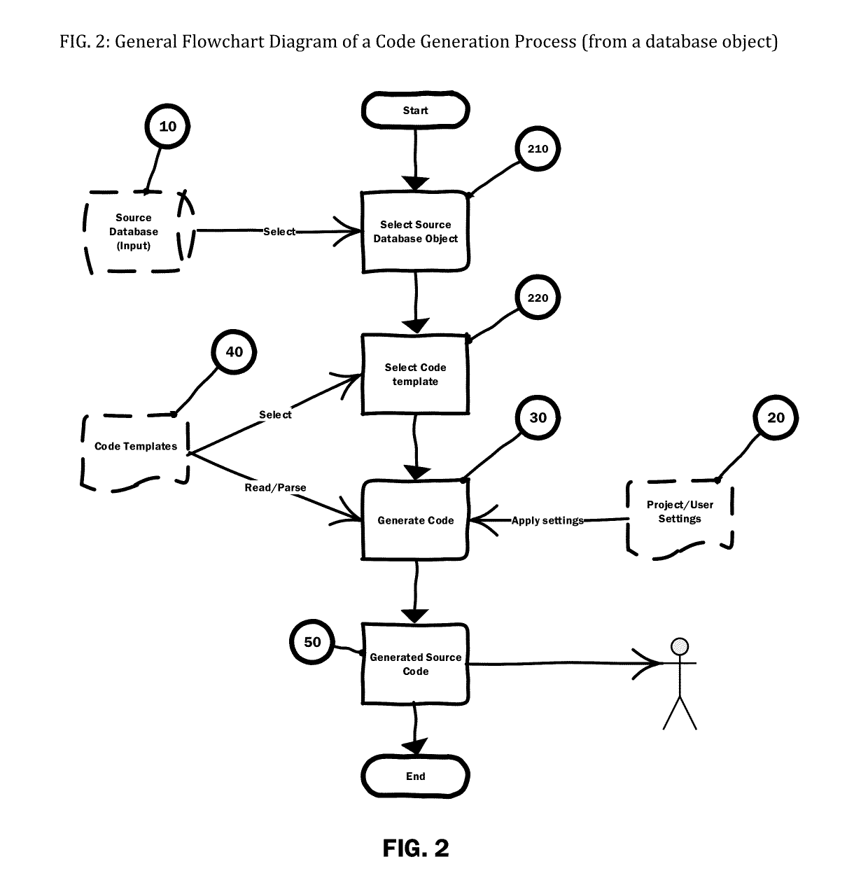

FIG. 2 is a flowchart diagram illustrating the source code generation process/method shown schematically in FIG. 1. Beginning at reference number 15, an application developer selects the source database object 210 from source database 10 and a code template at 220 as an input and submits request for code generation at reference number 30. The code generator utilizes information contained in the source database 10 for the selected source/database object 15, reads selected code template 40, applies user/project specific settings 20 and generates source code as an Output at 50. The code generation process terminates there and the application developer can take the generated source code and utilize the same to build theft software applications.

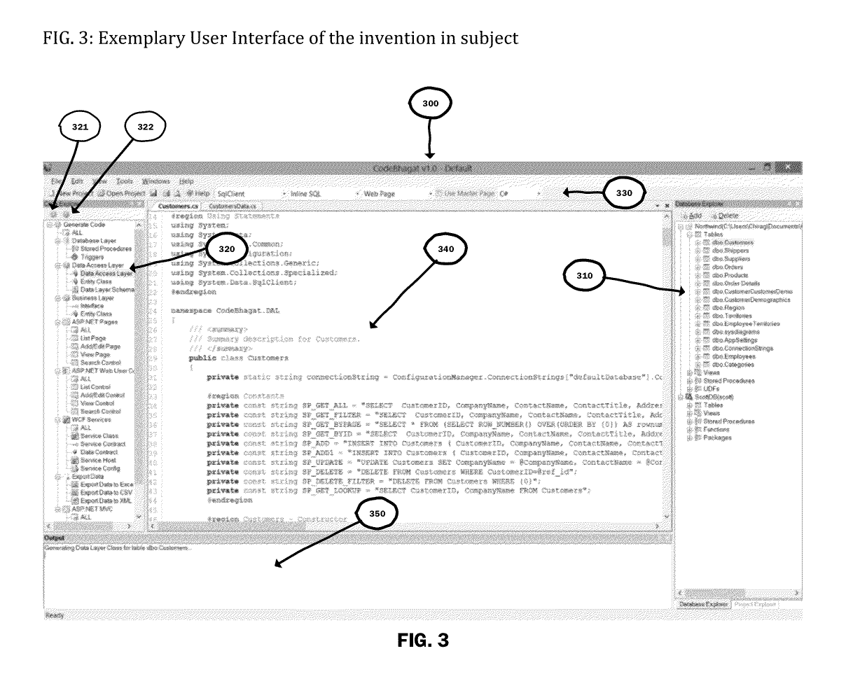

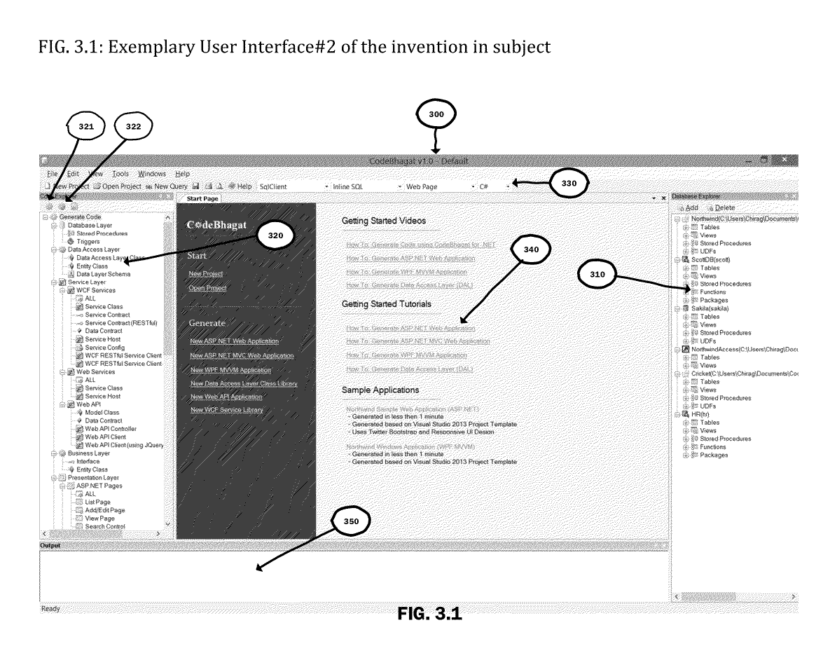

FIG. 3 is an exemplary code generator user interface 300 of the invention in subject depicting various parts of the screen design used to generate the source/program code, The normal usage flow uses the following steps:
1. Select the source database object(s) from the Database Explorer 310, if not already selected.
2. Select the code template from the Code Template Explorer 320, if not already selected. The application developer may choose the code template from available code templates and can generate code for any layer,
3. Use the “Quick Generate” 321 or “Generate” 322 button or double click on code template to Generate the source code. The “Quick Generate” does not require any input from the user for the generated code. I.e. name of the class, namespace, method names etc. This one-step or two-step process makes it very easy for the developer to generate their desired code quickly and use the same to build software application/component. The “Generate” 322 button will open a screen where the application developer can customize their needs for the code by specifying various parameters before they generate the program/source code.
4. The code generator reads the code template, apply the user/project specific settings and generate the source code which will be shown in the workspace area 340.
5. The output window 350 will show the progress status of the code generation in case of success and error messages in case of failure.

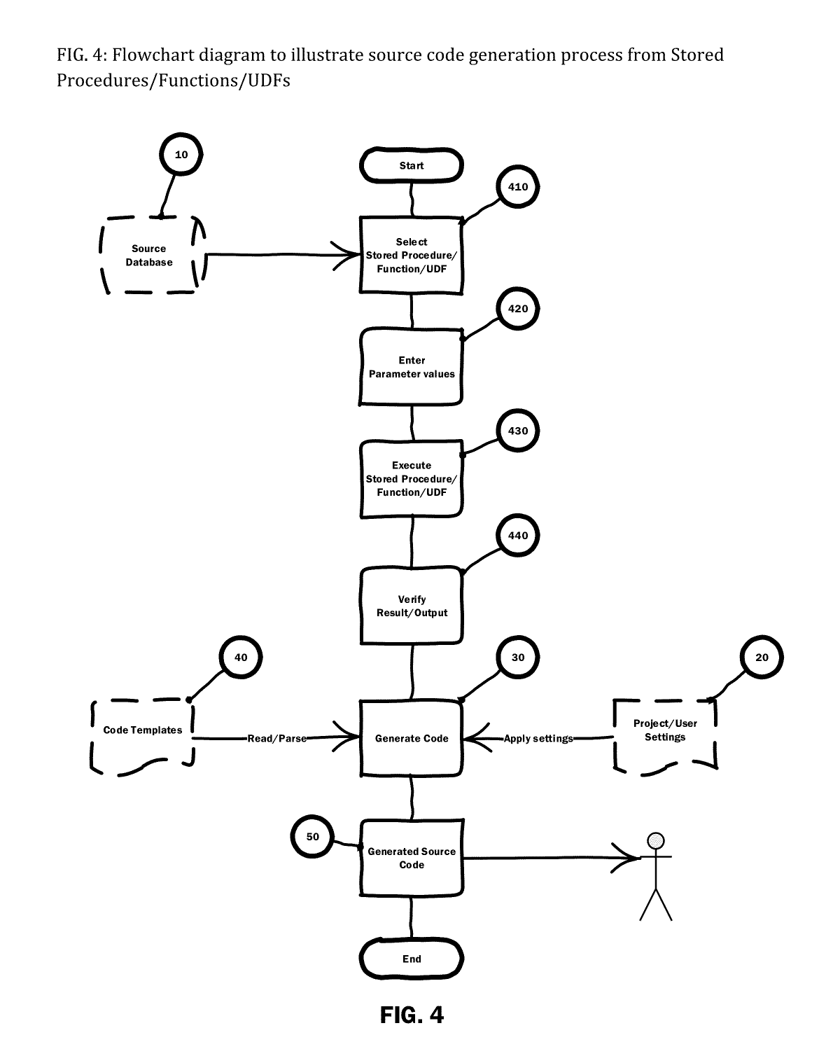

FIG. 4 is a flowchart diagram illustrating the source code generation process/method based on database stored procedures (SPs), functions or user defined functions (UDFs). Beginning at reference number 410, an application developer selects the source database object that is either a Stored Procedure, Function or User Defined Function. At reference 420, an application developer specifies the parameter values for the selected Stored Procedure, Function or User Defined Function in order to execute the same. At reference 430, an application developer executes the selected database object and at reference number 440, the output of the executed database object is shown and verified by the user and the code generation tool. Based on the resulting output, the user may further submit the request to generate the source code at reference number 30. The user may choose to generate various types of code including but not limited to user interface, methods, classes, web service, reports etc. The code generator utilizes information contained in the source database for the selected source/database object, reads selected code template 40, applies user/project specific settings 20 and generates source code as an Output 50. At reference number 450, the code generation process terminates there and the application developer can take the generated source code and utilize the same to build their software applications.

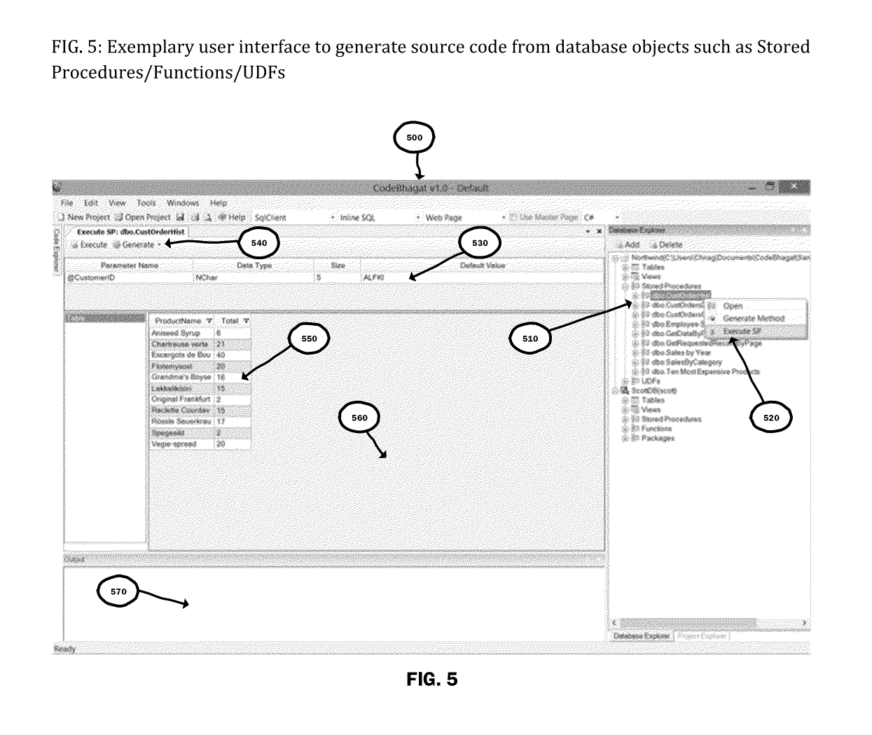

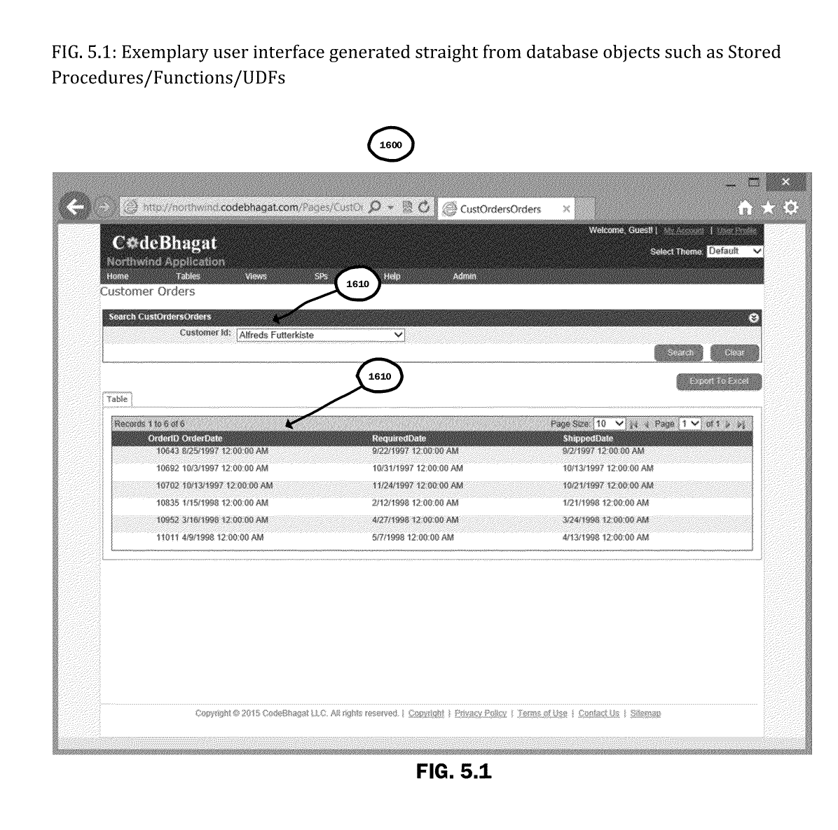

FIG. 5 is an exemplary depiction of code generator user interface 500 to facilitate code generation process shown in FIG. 4 depicting various parts of the screen used to generate the source/program code based on database stored procedures, functions or user defined functions. The normal usage flow uses the following steps:
1. Select the source database object(s) from the Database Explorer 510 which may include but not limited to Stored Procedures, Functions, Packages or User Defined Functions (UDFs).
2. Select the “Execute” action from the context menu 520 for the selected database object. The application developer will be presented with the screen to input the parameters for the selected database object before it can be executed.
3. The developer may enter the required parameter values at 530 for the selected database object in order to execute the same.
4. Use the “Execute” 540 button to execute the selected database object. The execution process will generate the resulting data that will be shown at 550.
5. Upon verification of the resulting data, use the “Generate” 540 menu item to generate the code for any layer including but not limited to user interface, methods, classes, web service, reports etc.
6. The code generator read the code template, apply the user/project specific settings and generate the source code which with be shown in the workspace area 560.
7. The output window 570 with show the progress status of the code generation in case of success and error messages in case of failure.

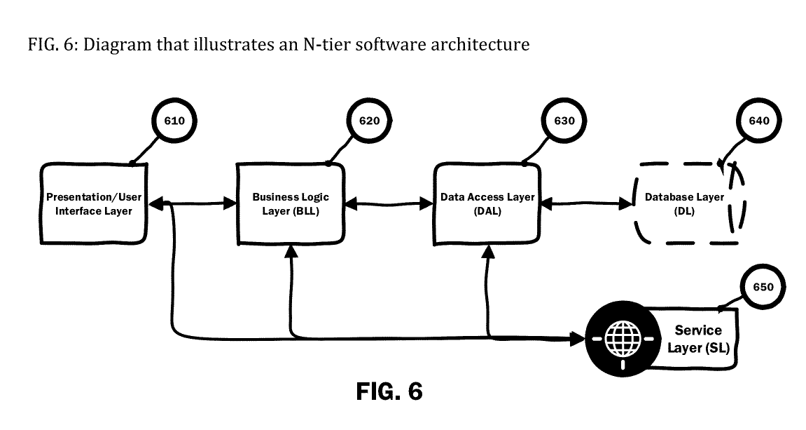

FIG. 6 illustrates an N-tier software architecture known in the software development art. N-tier application architecture provides a model by which developers can create flexible and reusable applications. The terms “tier” and “layer” are used synonymously. By segregating an application into multiple tiers, developers acquire the option of adding or modifying a specific layer, instead of reworking the entire application. The logical layer's of presentation or user interface 610, business logic 620, data access 630, data 640 and service 650 may reside on the same physical machine or on many physical machines. The data tier or layer 640 is a database management system, The purpose of this layer is the storage and retrieval of information. This layer can range from a Relational Database Management System (RDBMS) such as SQL Server, Sybase and Oracle to simple databases like MS-Access or plain text files, including Text/CSV/XML etc. The data access layer 630 is the interface to the data layer 640. it contains generic and specific methods that handle all data input and output and persist data into the database 640. The service layer 650 is the windows/web services interface to an internal or external APIs that may handle all information or data storage/process/retrieval activities. It contains methods that can be called from either same or different machine/network. The business logic layer 620 contains business entity objects, business rules/logic, data manipulation and transformation logic, etc. in other words, this layer manipulates and transforms data passed to it from the other layers. The business lode layer 620 is generally a bridge between presentation layer 610 and data access 630 or service layer 650. The presentation layer (user interface layer) 610 is the layer that provides a user interface for an end user into an application. It handles the transformation of the results output from other layers into something that is usable and readable by the end user.

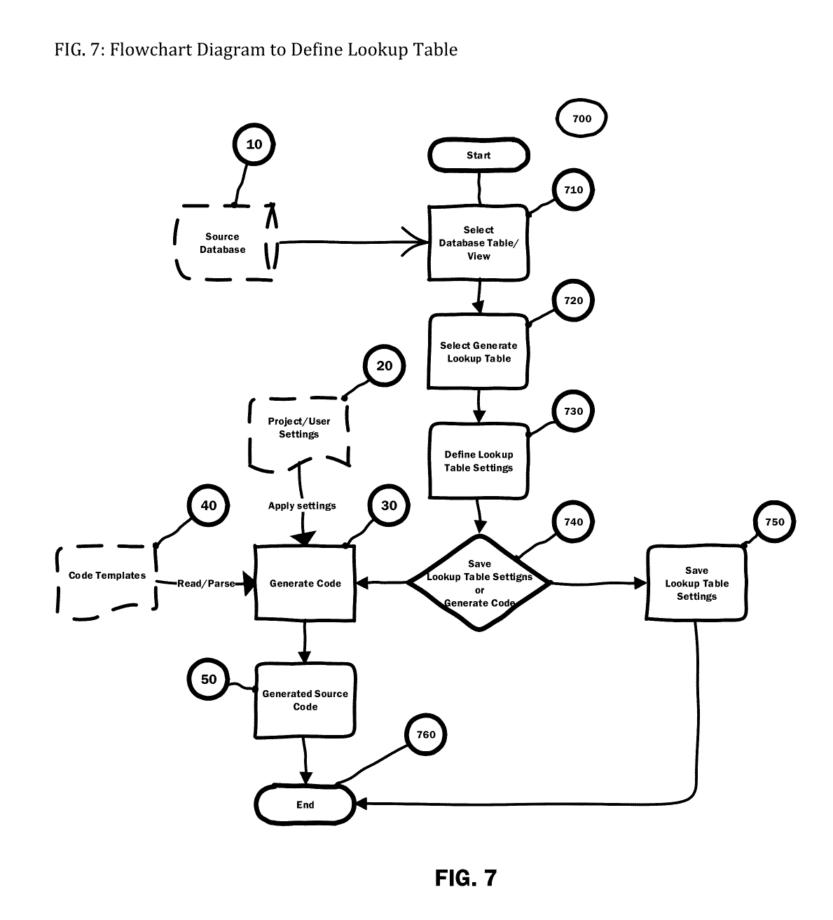

FIG. 7 is a flowchart diagram illustrating the process/method for defining the lookup (also called List of values (LOV)) for a database object, including but not limited to table, view, stored procedure, function etc, Beginning at reference number 710, an application developer selects a database object from source database 10. At reference 720, an application developer selects the option to define lookup and selects/enters necessary parameters/settings at reference number 730. At reference 740, an application developer decides to save the settings or generate the code for the lookup based on their needs. At reference number 750, the lookup settings are saved for the selected object and will automatically be used later in code generation for the selected database object. At reference number 30, the user may choose to generate various types of code and submit the request to generate the code based on lookup settings defined for the selected database object. The code generator utilizes information contained in the source database for the selected source/database object, reads selected code template 40, applies user/project specific settings 20 and generates source code as an Output 50. At reference number 760, the code generation process terminates there and the application developer can take the generated source code and utilize the same to build their software applications.

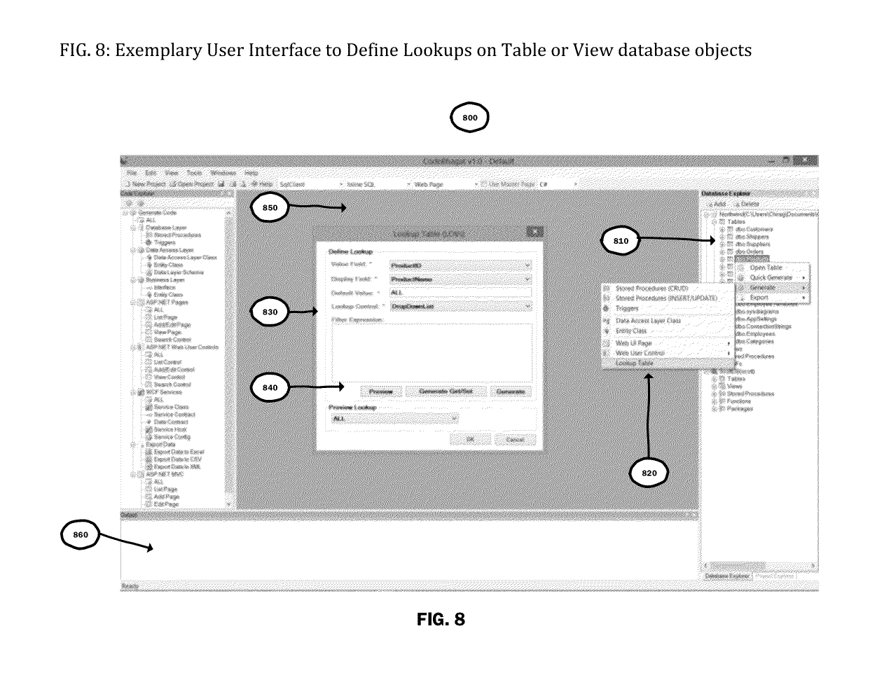

FIG. 8 is an exemplary depiction of code generator user interface to define lookup tables (LOVs) 800 to facilitate process shown in FIG. 7 depicting various parts of the screen used to define the lookup and generate the source/program code. The normal usage flow uses the following steps:
1. Select the source database object(s) from the Database Explorer 810.
2. Select the “Generate” “Lookup Table” action from the context menu 820. The application developer will be presented with the screen to input the parameters for the selected object to define the lookup.
3. The developer may enter the parameter values required in order to define the lookup 830 for the selected object and selected settings will be saved for later use while generating code for the selected object.
4. The application developer may use the “Generate” or “Generate Get/Set” 840 button to generate the desired source code for the lookup. The user may choose to preview the data/lookup by using “Preview” button.
5. While generating the code for the selected database object, the code generator reads the code template, apply the user/project specific settings and generate the source code which will be shown in the workspace area 850.
6. The output window 860 will show the progress status of the code generation in case of success and error messages in case of failure.

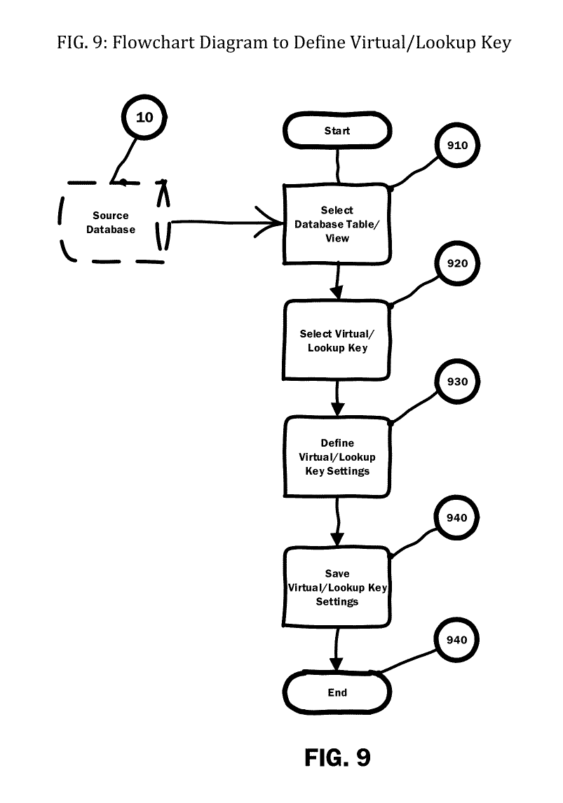

FIG. 9 is a flowchart diagram illustrating the process/method for defining the virtual or lookup key (also called List of values (LOV)) straight by selecting the column or parameter of a database object, including but not limited to table, view, stored procedure, function etc. Beginning at reference number 910, an application developer selects the source database object from source database 10. At reference 920, an application developer selects the option to define virtual or lookup key and selects/enters necessary parameters/settings at reference number 930. At reference 940, an application developer decides to save the settings or Generate the code for the lookup based on their needs. At reference number 940, the virtual or lookup key settings are saved for the column or parameter of a selected object that will automatically be used later in code Generation process for the selected database object. At reference number 950, the process terminates there and the application developer may later choose to generate source code and the settings saved for virtual/lookup key will automatically be applied on the generated source code.

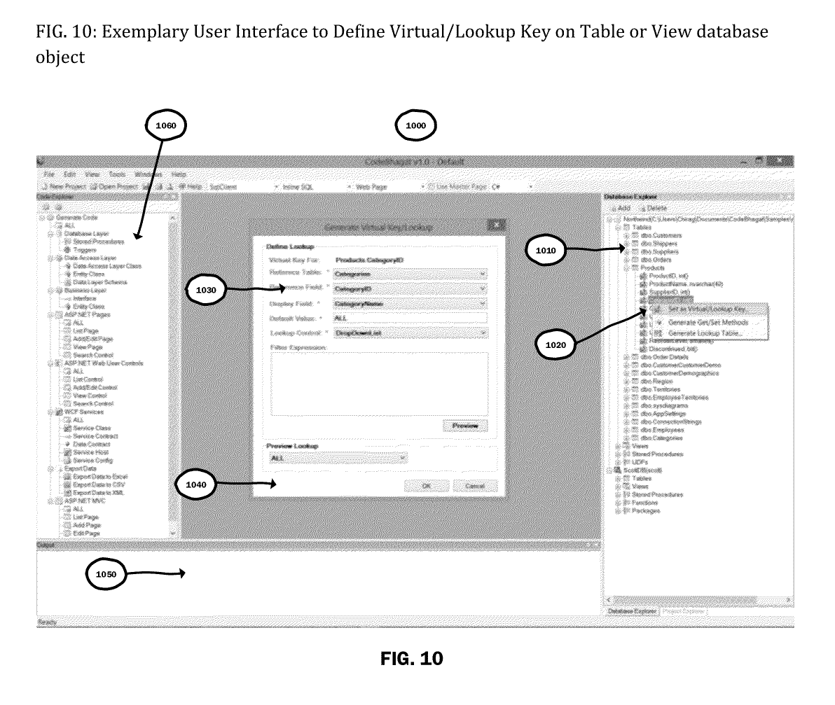

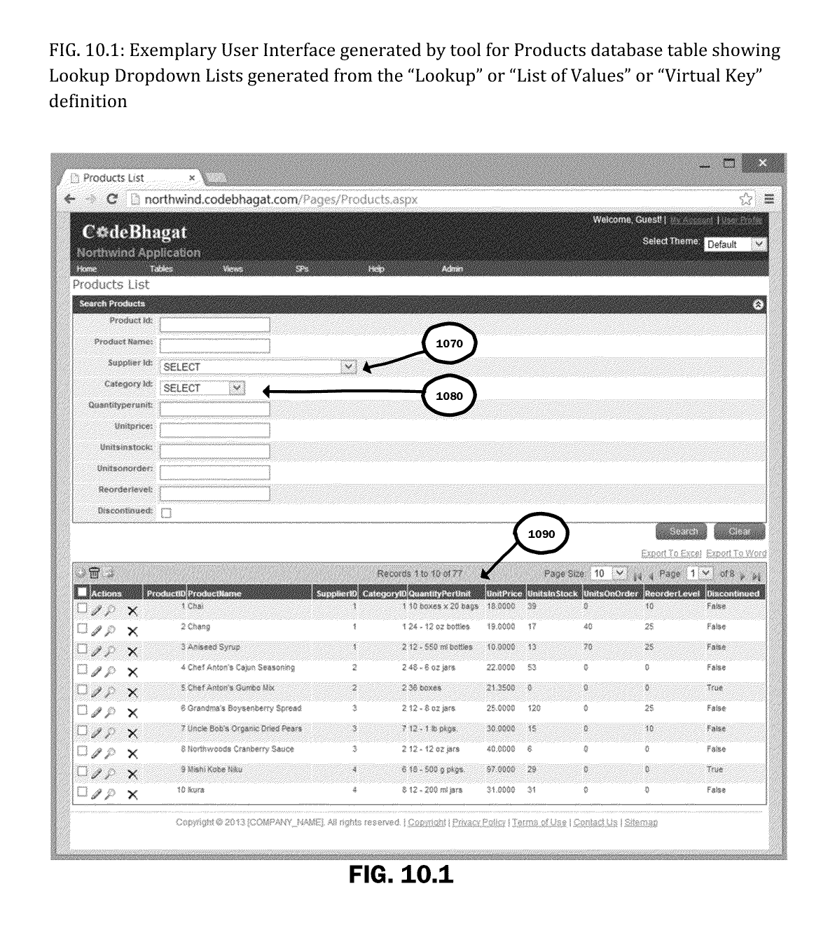

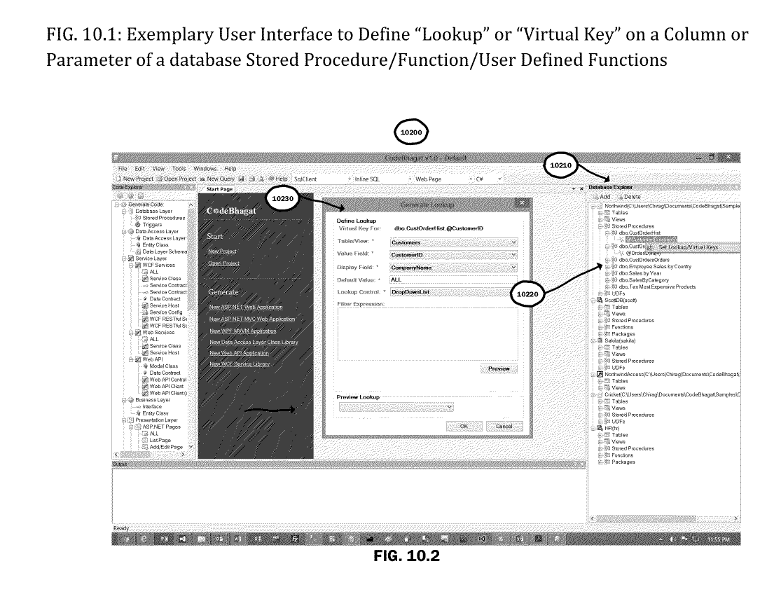

FIG. 10 is an exemplary depiction of code generator user interface to define virtual/lookup keys (LOVs) 1000 to facilitate process shown in FIG. 9 depicting various parts of the screen used to define the virtual/lookup keys. The normal usage flow uses the following steps:
7. Select the column or parameter of a source database object from the Database Explorer 1010.
8. Select the “Set as Virtual/Lookup Key” action from the context menu 1020 for the selected column or parameter of a database object. The application developer will be presented with the screen to input the relationship parameters for the selected column/parameter to define the virtual/lookup key.
9. The developer may enter the parameter values required in order to define the relation for virtual/lookup key 1030 for the selected column/parameter of a database object and allows the selected settings to be saved for later use while generating code for the selected object.
10. Use the “OK” 1040 button to save the settings for the virtual/lookup key. The user may choose to preview the data/lookup by using “Preview” button.
11. The output window 1050 will show the progress status in case of success and error messages in case of failure while defining the virtual/lookup key.

Upon defining the virtual/lookup key, the developer may choose to generate the desired code straight from Code Template Explorer 1060 or use context menu 1020 for a selected database object. The settings saved for virtual/lookup key will automatically be applied on the generated code for the selected database object.

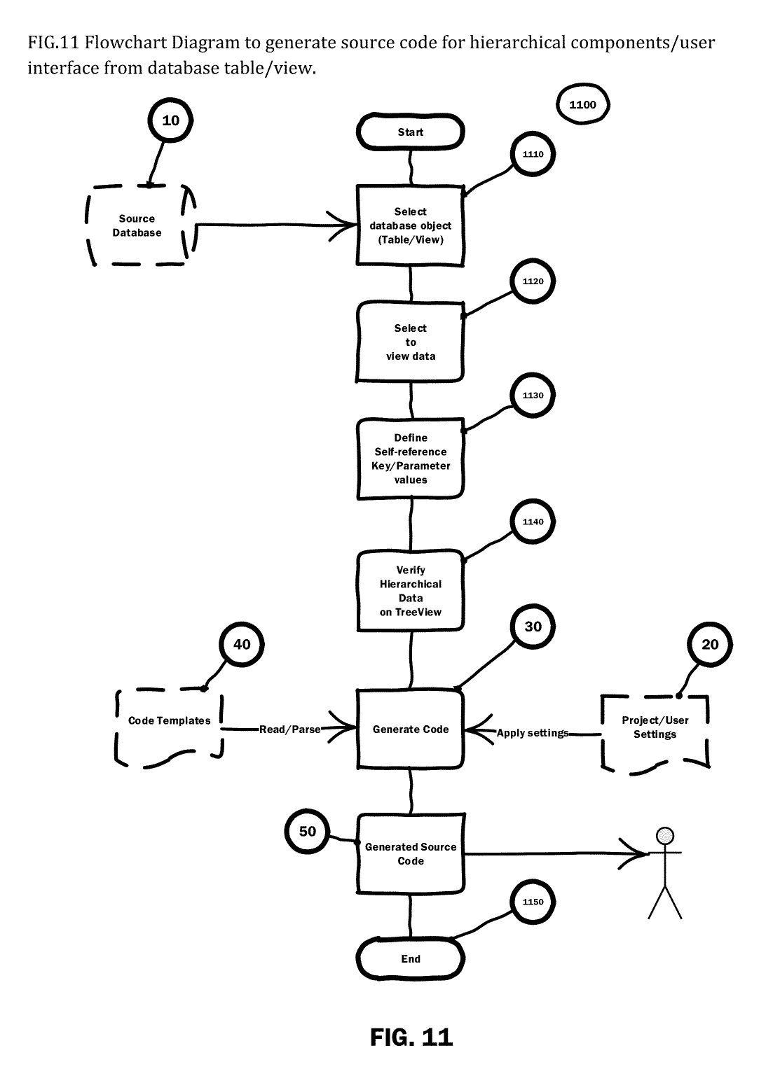

FIG. 11 is a flowchart diagram illustrating the process/method for generating source code/components 1100 that will help build hierarchical user interface or components such as Tree View, Windows Explorer or Outlook where hierarchical data is shown on left navigation panel, details of the selected node is shown on right top panel and the list of child items shown on right bottom panel of the screen. The developer may choose to generate individual components. Beginning at reference number 1110, an application developer selects the source database object 1110 from a source database 10. At reference 1120, an application developer selects the option to view data for the selected database object, if the relationship exist between two columns of the same selected database object, a hierarchical view is presented to the user. At reference 1130, an application developer defines a relationship or self-reference key between the two columns of the selected database object and the selected settings are saved for the selected object. At reference number 1140, a hierarchical view is presented to the developer who may verify the hierarchical data on TreeView panel. Upon defining the relationship or self-reference key, the developer may choose to generate the desired code straight from Code Template Explorer or use menu or context menu. The relationship settings defined will automatically be applied on the generated code and respective source code for hierarchical user interface/components are generated based on selected code template.

The code generator utilizes information contained in the source database for the selected source/database object, reads selected code template 40, applies user/project specific settings 20, applies the relationship or self-reference key settings and generates source code to build hierarchical user interface/components such as Tree View, Windows Explorer or Outlook like user interface as an Output 50. At reference number 1150, the code generation process terminates there and the application developer can take the generated source code and utilize the same to build their software applications. The same technique or method may be utilized to generate source code for variety of N-tier/hierarchical components, and should not limit the scope of the technique or method used herein.

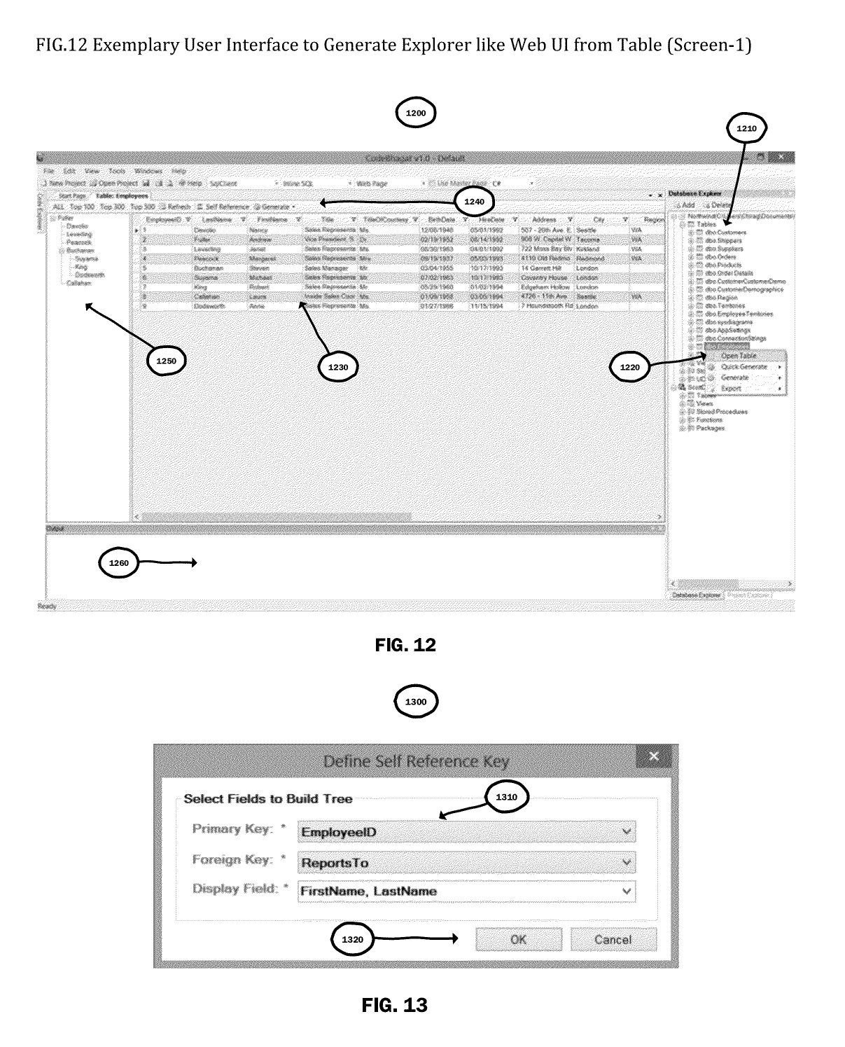

FIG. 12 is an exemplary depiction of code generator user interface 1200 to facilitate process shown in FIG. 11 depicting various parts of the screen used to define relationship or self-reference key, present/verify the hierarchical view of the relationship and generate the source code/components to build N-tier/hierarchical software application components. The normal usage flow uses the following steps:
1. Select the source database object(s) from the Database Explorer 1210 panel.
2. Select the “Open Table” action from the context menu 1220 on selected database object. The application developer will be presented with the screen to view the data for the selected database object. If the relationship or self-reference key already exist for the selected database object, a hierarchical view 1250 is also presented to the developer.
3. The developer may choose to define/modify the relationship or self-reference key settings by using “Self Reference” menu button and a screen to Define self-reference key settings FIG. 13 is provided,
4. The user may select the fields to define the relationship or self-reference key 1310 for the selected database object and use the “OK” 1330 button to save the settings.
5. The tree view panel 1250 will be updated to display the hierarchical data based on the relationship defined in FIG. 13.
6. The user may choose to drag-n-drop the nodes and re-arrange the hierarchy/tree view data and update the record in the database system.
7. Upon defining the relationship or self-reference key, the developer may choose to generate the desired source code/components straight from Code Template Explorer or use “Generate” menu 1240 to build N-tier/hierarchical software application components. The settings saved for relationship or self-reference key will automatically be applied on the generated source code/component.
8. The output window 1260 will show the progress status in case of success and error messages in case of failure while defining the virtual/lookup key.

FIG. 13 is an exemplary depiction of user interface to facilitate define relationship or self-reference key 1300. The normal usage flow uses the following steps:
1. Use the “Define Self-Reference Key” from the menu shown in FIG. 12 or use context menu on the selected database object from Database Explorer 1210 panel.
2. The screen to define self-reference key 1300 will be provided.
3. The user may select the primary/foreign key fields to define the relationship or self-reference key 1310 for the selected database object and use the “OK” 1320 button to save the settings.

The same technique or method may be utilized to define relationship or key between two or more database objects such as tables, views etc. and should not limit the scope of the technique or method used herein.

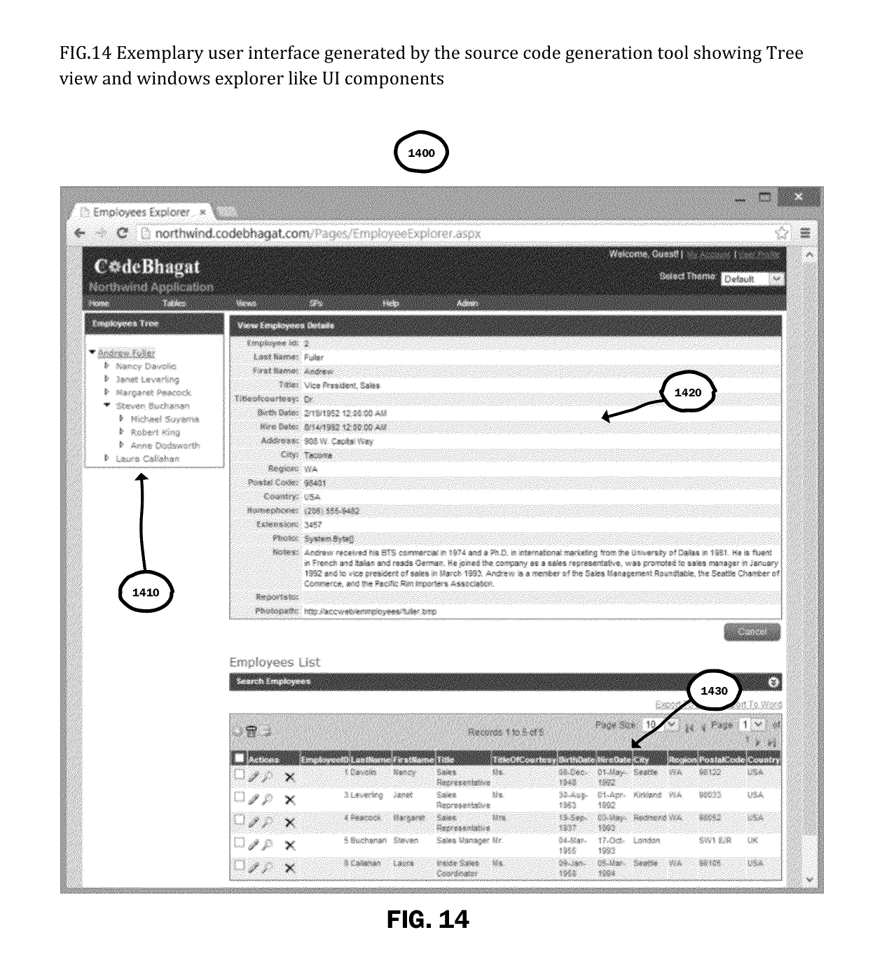

FIG. 14 is an exemplary depiction of user interface components generated by the tool based on the code generation process shown in FIG. 11 showing Tree view and windows explorer like UI components were generated.

Reference number 1410 is a tree view user interface component generated based on the self-reference key defined for a table/view, Reference number 1420 is a view details user interface component where the details of the node selected in tree view component 1410 is displayed, Reference number 1430 is a list of child items user interface components where the child items of the node selected in tree view component 1410 is displayed,

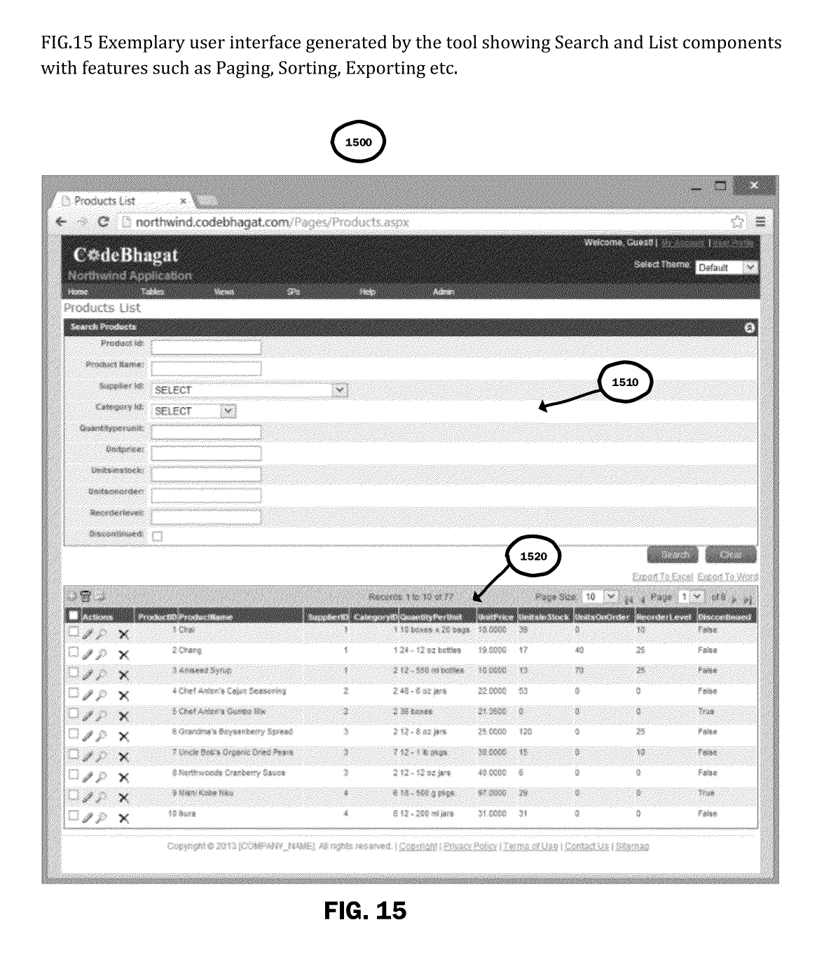

FIG. 15 is an exemplary depiction of user interface components generated by the tool showing Search and List components with features such as Paging, Sorting, and Exporting etc.

Reference number 1510 is a Search user interface component generated based on the selected database object where the user is provided with the ability to search for the records. Reference number 1520 is a user interface components with list of records shown where the user is provided with the ability to navigate between pages, select the records to add/edit/delete and export the data to excel/word/pdf formats etc.

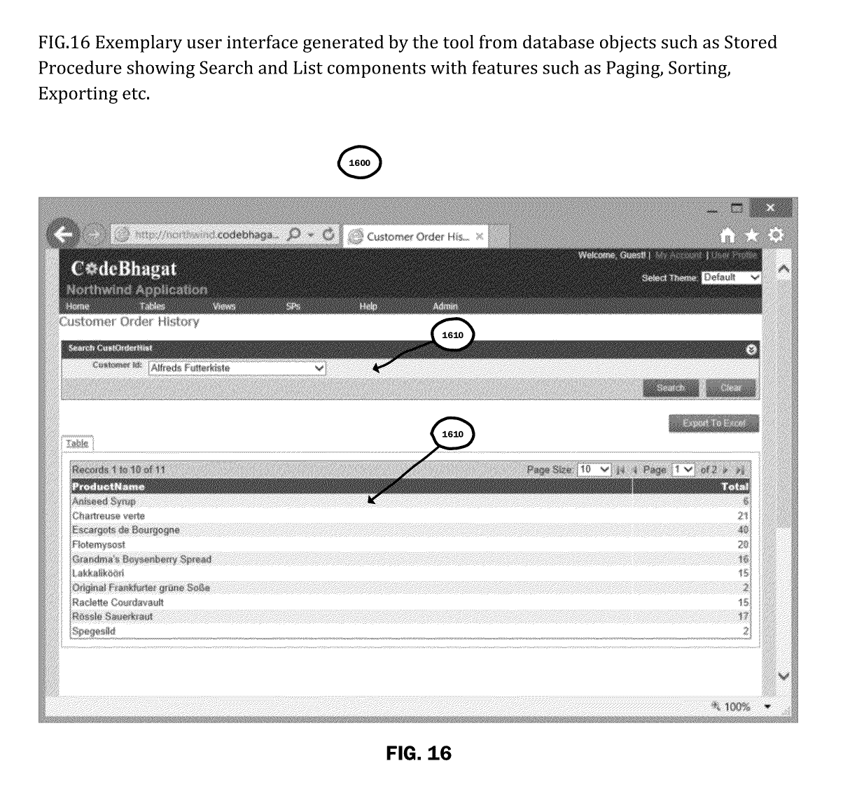

FIG. 16 is an exemplary depiction of user interface components generated by the tool based on the code generation process shown in FIG, 4 showing Search (Execution) and List components with multiple outputs and features such as Paging, Sorting, and Exporting etc.

Reference number 1610 is a Search user interface component generate based on the selected database object where the user is provided with the ability to search for the records. The search parameter generated for the search user interface screen is based on the lookups/virtual keys defined for the selected object as shown in FIG. 9 and FIG. 10. This will execute a selected stored procedure, function or user defined function. Reference number 1620 is a user interface component with list of records shown where the user is provided with the ability to navigate between pages, select the records to add/edit/delete and export the data to excel/word/pdf formats etc. If the execution of the selected database object generates multiple outputs, they all will be generated and displayed in different tabs on the user interface.

The invention claimed is:

1. Quick Generate: A method for easily generating program/source code for building an N-tier or multiple layer software application with common and reusable components into a generated computer shell ready for use, comprising:
Two-Step Process: 1) Selecting a database object from a source database system, if not already selected, and 2) Selecting a code template or component to generate the source code;
One-Step Process: 1) Selecting a code template or component for an already selected database object to generate the source code;
Providing quick generation method by using simple One-Step or Two-Step process of generating source code;
Where the code generation process is, Utilizing pure XML based code generation templates that include string replacement variables that can be easily customized to generate or re-generate the source code; and
Where the code generation process is, Utilizing “Virtual Keys”, “Lookups” or “List of Values” (LOVs) defined for specific Column(s) or Parameter(s) of a “Database Object” while generating software applications or common and reusable components of source code straight from a database object.

2. The method according to claim 1 (Quick Generate by using either Two-Step Process or One-Step Process) can be utilized to generate the source code for N-tier or multiple layers of software application that include but not limited to Database Layer, Service Layer, Data Access Layer, Business Logic Layer and User Interface layer.

3. The method according to claim 1 (Quick Generate by using either Two-Step Process or One-Step Process) can be utilized to generate the source code for any programming language, database language or scripting language that include but not limited to C#.NET, VB.NET, ASP.NET, HTML, WPF, MVC, MVVM, Java, JavaScript, PHP, Python, SQL, PL/SQL, T-SQL etc.

4. The method according to claim 1 (Quick Generate by using either Two-Step Process or One-Step Process) can be utilized to generate the source code straight from on any database, or relational database system that include but not limited to SQL Server, SQL Azure, Oracle, Sybase, MySQL, MS-Access, MS-Excel, CSV and other relational/hierarchical/network/cloud/file based databases.

5. The method according to claim 1 (Quick Generate by using either Two-Step Process or One-Step Process) can be utilized to generate the source code straight from any Database Object Type that include but not limited to Tables, Views, Queries, Stored Procedures, Packages, Functions, User Defined Functions, Types, and User Defined Types.

6. The method according to claim 1 (Quick Generate by using either Two-Step Process or One-Step Process) further comprising a code generator user interface.

7. The method according to claim 1 (Quick Generate by using either Two-Step Process or One-Step Process) can be utilized to generate the source code wherein the code generator user interface provides various options to the user to easily change the Programming Language, Database Provider, Command Type, User or Project specific settings such as Target Output Path, Namespace of an application or component etc. before the user can generate the code.

8. The method according to claim 1 (Quick Generate by using either Two-Step Process or One-Step Process) can be utilized to generate the source code for any type of applications that include but not limited to a Web-based, Mobile, Console or Desktop applications.

9. The method according to claim 1 (Quick Generate by using either Two-Step Process or One-Step Process) can be utilized to generate the user interface and source code for the type of software application technologies that include but not limited to ASP.NET Web Application, ASP.NET MVC Web Application, WPF MVVM Application, WCF Service Library/component, Web API Service Application, Data Access Layer Library/component.

10. The method according to claim 1 (Quick Generate by using either Two-Step Process or One-Step Process) wherein existing code template may be customized and/or New Code Templates can be added to provide additional facility to developers to generate or re-generate the code using their preferred new patterns/methods/styles of coding.

11. The method according to claim 1 (Quick Generate by using either Two-Step Process or One-Step Process) can be utilized based on “Virtual Keys”, “Lookups” or “List of Values” defined, to generate different type of a user interfaces, common and reusable components in various layer including but not limited to Database Layer, Service Layer, Data Access Layer, Business Logic Layer and User Interface Layer.

12. Generate source code straight from Database Objects such as Stored Procedures and Functions (other than Tables and Views): A method for executing and generating program/source code, using only Two-Step or Three-Step process, based on an input database objects such as Stored Procedures, Functions, User Defined Functions, Packages etc., for building an N-tier or multiple layer software application with common and reusable components into a generated computer shell ready for use, comprising:
Step-1: Executing a selected database object from a source database system, if not already selected;
Step-2: Verifying and analyzing the output generated by executing a database object (optional step);
Step-3: Generating source code straight from the selected database object;
Where the code generation process is, Utilizing “Virtual Keys”, “Lookups” or “List Of Values” (LOVs) defined for specific Column(s) or Parameter(s) of a “Database Object” while generating software applications or common and reusable components of source code straight from a database object; and
Where the code generation process is, Executing and generating source code for common and reusable components of N-tier or multiple layers straight from database objects such as stored procedures, functions, user defined functions, packages etc and other than Tables and Views.

13. The method according to claim 12 (Generate source code straight from Database Objects such as Stored Procedures and Functions) can be utilized to generate the source code straight from the input database objects such as Stored Procedures, Functions, User Defined Functions, Packages, Macros etc.

14. The method according to claim 12 (Generate source code straight from Database Objects such as Stored Procedures and Functions) can be utilized to generate the source code for N-tier or multiple layers of software application that include but not limited to a Database Layer, a Service Layer, a Data Access Layer, a Business Logic Layer and a User Interface Layer.

15. The method according to claim 12 (Generate source code straight from Database Objects such as Stored Procedures and Functions) can be utilized to generate the source code for any programming language, database language or scripting language that include but not limited to C#.NET, VB.NET, ASP.NET, HTML, WPF, MVC, MVVM, Java, JavaScript, PHP, Python, SQL, PL/SQL, T-SQL etc.

16. The method according to claim 12 (Generate source code straight from Database Objects such as Stored Procedures and Functions) can be utilized to generate the source code that include but not limited to a user interface components/controls, a business layer entity classes, methods for all layers, a web/WCF service, a Data Access Layer, a Business Logic Layer and a User Interface Layer.

17. The method according to claim 12 (Generate source code straight from Database Objects such as Stored Procedures and Functions) can be utilized to generate the source code for any programming language, database language or scripting language that include but not limited to C#.NET, VB.NET, ASP.NET, HTML, WPF, MVC, MVVM, Java, JavaScript, PHP, Python, SQL, PL/SQL, T-SQL etc.

18. The method according to claim 12 (Generate source code straight from Database Objects such as Stored Procedures and Functions) can be utilized to generate the source code straight from any database or relational database system that include but not limited to SQL Server, SQL Azure, Oracle, Sybase, MySQL, MS-Access, MS-Excel, CSV and other relational/hierarchical/network/cloud/file based databases.

19. The method according to claim 12 (Generate source code straight from Database Objects such as Stored Procedures and Functions) can be utilized to generate the source code for any type of applications that include but not limited to a Web-based, Mobile, Console or Desktop applications.

20. The method according to claim 12 (Generate source code straight from Database Objects such as Stored Procedures and Functions) further comprising a code generator user interface.

21. The method according to claim 12 (Generate source code straight from Database Objects such as Stored Procedures and Functions) can be utilized to generate the user interface and source code for the type of software application technologies that include but not limited to ASP.NET Web Application, ASP.NET MVC Web Application, WPF MVVM Application, WCF Service Library/component, Web API Service Application, Data Access Layer Library/component.

22. The method according to claim 12 (Generate source code straight from Database Objects such as Stored Procedures and Functions) wherein existing code template may be customized and/or New Code Templates can be added to provide additional facility to developers to generate or re-generate the code using their preferred new patterns/methods/styles of coding.

23. The method according to claim 12 (Generate source code straight from Database Objects such as Stored Procedures and Functions) can be utilized based on “Virtual Keys”, “Lookups” or “List of Values” defined, to generate common and reusable components that contain the relationships between two or more objects and generate user interfaces that contain lookup controls.

24. The method according to claim 12 (Generate source code straight from Database Objects such as Stored Procedures and Functions) can be utilized to generate the type of user interface, wherein 1) the Search user interface components are generated automatically based on the List of Parameters of a selected object, and 2) the List or Grid user interface components are generated based on the Result Set with multiple table output, along with paging, sorting and exporting features on each output user interface.

25. Define Lookups and Generate source code based on Lookups defined on Table or View database object: A method for defining Lookups or List of Values (LOVs) for a database Table or View, to be further utilized in code generation process, comprising:
Step-1: Selecting a database object from source database system;
Step-2: Defining parameters for a Lookup or List of Values;
Step-3: Verifying the lookup data and applying filter criteria;
Step-4: Storing the lookup settings defined to further utilize in code generation process;
Where the code generation process is, Utilizing the Lookups or List of Values (LOVs) defined for a Table or View database object while generating source code for common and reusable components; and.

26. The method according to claim 25 (Define Lookups and Generate source code based on Lookups defined on Table or View database object) further comprising utilizing the lookups defined in the code generation process as described in claim 1 and claim 12.

27. The method according to claim 25 (Define Lookups and Generate source code based on Lookups defined on Table or View database object) further comprising a user interface for defining lookups as shown in FIG. 8.

28. Define Lookups on a Column or Parameter of any database object: A method for easily defining Virtual Keys and setting up “Lookups” or “List of Values” (LOVs) for a Column or Parameter of any database object (not limited to Tables and Views) such as Tables, Views, Stored Procedures, User Defined Functions etc., using only Two-Step process, to be further utilized in code generation process, comprising:
Step-1: Selecting a column or parameter of a database object from a source database system, if not already selected;
Step-2: Defining a relationship with other database object column or parameter, and storing the Virtual Key and lookup settings defined to further utilize in code generation process;
Where the code generation process is, Utilizing the Virtual Keys or Lookups or List of Values (LOVs) defined for a column or parameter of a database object while generating source code for common and reusable components straight from a selected database object; and
Where the code generation process is, Executing and generating source code for common and reusable components that contain the relationships between two or more objects and generate user interfaces that contain lookup controls.

29. The method according to claim 28 (Define Lookups on a Column or Parameter of any database object) further comprising utilizing the lookups defined in the code generation process as described in claim 1 and claim 12.

30. The method according to claim 28 (Define Lookups on a Column or Parameter of any database object) further comprising a user interface for defining virtual keys and setting up lookups (LOVs) as shown in FIG. 10.

31. Define and Generate source code based on Self-Reference or Self-Join Keys: A method for easily defining relationship or self-reference key for a database Table or View, using only 2-step or 3-step process, and utilizing the same database object and relationship for generating program/source code for building common and reusable hierarchical components into a generated computer shell ready for use, comprising:
Step-1: Selecting a database Table or View from a source database system to view data, if not already selected;
Step-2: Defining and storing a relationship or self-reference or self-join key with another column or parameter of same database Table or View, if not already defined;
Step-3: Presenting and verifying data in a hierarchical view, allowing to adjust the parameters before generating the code;
Where the code generation process is, Utilizing the self-reference or self-join key settings defined in code generation process; and
Where the code generation process is, Generating source code for common and reusable components of N-tier or multiple layers straight from the selected database objects.

32. The method according to claim 31 (Define and Generate source code based on Self-Reference or Self-Join Keys) further comprising a unique method and/or user interface for defining a relation or self-reference key, presenting hierarchical data view and generating source code.

33. The method according to claim 31 (Define and Generate source code based on Self-Reference or Self-Join Keys) wherein the Self-Reference or Self-Join can be defined on input database objects that include but not limited to tables, views and queries.

34. The method according to claim 31 (Define and Generate source code based on Self-Reference or Self-Join Keys) wherein the source code generated for N-tier or multiple layers include but not limited to Database Layer, Service Layer, Data Access Layer, Business Logic Layer and Presentation or User Interface Layer.

35. The method according to claim 31 (Define and Generate source code based on Self-Reference or Self-Join Keys) can be utilized based on “Virtual Keys”, “Lookups” or “List of Values” defined, to generate common and reusable components that contain the Self-Reference or Self-Join relationships for the same database object and generate User Interfaces that contain lookup controls.

36. The method according to claim 31 (Define and Generate source code based on Self-Reference or Self-Join Keys) wherein the generated program/source code include but not limited to a user interface components/controls, a business layer entity classes, methods for all layers, a Web/WCF service, Web APIs, Data Access Layer, Business Logic Layer and User Interface Layer.

37. The method according to claim 31 (Define and Generate source code based on Self-Reference or Self-Join Keys) can be utilized to generate the source code for any programming/database/scripting language that include but not limited to C#.NET, VB.NET, ASP.NET, HTML, WPF, MVC, MVVM, Java, JavaScript, PHP, Python, SQL, PL/SQL, T-SQL etc.

38. The method according to claim 31 (Define and Generate source code based on Self-Reference or Self-Join Keys) can be utilized to generate the source code straight from any database systems that include but not limited to SQL Server, SQL Azure, Oracle, Sybase, MySQL, MS-Access, MS-Excel, CSV and other relational/hierarchical/network/cloud/file based databases etc.

39. The method according to claim 31 (Define and Generate source code based on Self-Reference or Self-Join Keys) can be utilized to generate the source code for any type of applications that include but not limited to a Web-based, Mobile, Console or Desktop applications.

40. The method according to claim 31 (Define and Generate source code based on Self-Reference or Self-Join Keys) further comprising a unique hierarchical user interface generated by the program.

41. The method according to claim 31 (Define and Generate source code based on Self-Reference or Self-Join Keys) can be utilized to generate the user interface and source code for the type of software application framework/technologies that include but not limited to ASP.NET Web Application, ASP.NET MVC Web Application, WPF MVVM Application, WCF Service Library/component, Web API Service Application, Data Access Layer Library/component.

42. The method according to claim 31 (Define and Generate source code based on Self-Reference or Self-Join Keys) wherein existing code template may be customized and/or New Code Templates can be added to provide additional facility to developers to generate or re-generate the code using their preferred new patterns/methods/styles of coding.

43. The method according to claim 31 (Define and Generate source code based on Self-Reference or Self-Join Keys) further comprising the type of a source code generated for various layer including but not limited to a Database Layer, a Service Layer, a Data Access Layer, a Business Logic Layer and a User Interface Layer, including utilizing lookups defined for the column/parameter of a selected database object.
